(19) United States
(12) Patent Application Publication
(10) Pub. No.: US 2025/0274375 A1
(43) Pub. Date: Aug. 28, 2025

(54) SYSTEMS FOR CALL MONITORING AND ASSOCIATED METHODS

(71) Applicant: AVOXI, INC., Atlanta, GA (US)

(72) Inventors: Randy Layman, Marietta, GA (US); Keith Meyers, Senoia, GA (US); Robert Rushton, Pelham, AL (US); Vinay Sangawar, Atlanta, GA (US); Kathleen Gilbert, Pittsburgh, PA (US); Samantha Dyer, Atlanta, GA (US); Khadishia Senior, Dallas, TX (US)

(21) Appl. No.: 19/052,408

(22) Filed: Feb. 13, 2025

Related U.S. Application Data
(60) Provisional application No. 63/556,448, filed on Feb. 22, 2024.

(51) Int. Cl. H04L 43/50; H04L 43/0829; H04L 43/087; H04L 65/1045

(52) U.S. Cl. CPC H04L 43/50; H04L 43/0829; H04L 43/087; H04L 65/1045

(57) ABSTRACT

A system for monitoring call quality may include a monitoring environment. The monitoring environment may be operable to obtain information associated with a call between two or more computing devices, and may generate a composite quality score for the call based on the information. The composite quality score may be based on values of a plurality of parameters associated with the call. A method of monitoring call quality is also disclosed.

### CROSS-REFERENCE TO RELATED APPLICATION

The present disclosure claims the benefit of U.S. Provisional Application No. 63/556,448 filed Feb. 22, 2024, which is incorporated herein by reference in its entirety.

### BACKGROUND

This disclosure relates to telephony systems, including monitoring of call quality between communications devices.

Call quality may be measured using various techniques. The measured information may be assigned a Mean Opinion Score (MOS) or Perceptual Evaluation of Speech Quality (PESQ) score. Call quality may be measured by comparing what is sent at the transmitter end of the call and what is received at the termination end of the call. One technique for measuring call quality may include active testing. Test calls may be periodically made where both ends are controlled by a test system, allowing the test system to measure the MOS of the call. This method may be accurate for the exact communication path that is tested, but it may provide different information from actual users because the actual users may be using a variety of devices and communication partners to make the phone calls. Call quality may vary by time of the day due to system loads which may affect the resources available to process phone calls.

Another technique for measuring call quality may include monitoring all calls as they pass through a single point of a respective call between users. All calls may be measured, but it may provide limited visibility because only a single point of the call may be checked.

Latency is the amount of time it takes an audio packet to travel from a sender to a receiver. This time may be influenced by the distance between two locations, but may be more significantly influenced by the number of network elements (e.g., routers, switches, etc.) and the number of telephony devices (e.g., Session Border Controllers, SIP Application Servers, Media Proxies, etc.) and their configuration. Transcoding (e.g., changing the audio format) and encryption may contribute latency to calls. The latency may also vary due to load on the various network devices and changes in networking topology.

### SUMMARY

A system for monitoring call quality may include one or more processors coupled to memory. The one or more processors may be collectively operable to execute a monitoring environment. The monitoring environment may be operable to obtain information associated with a call between two or more computing devices. The monitoring environment may be operable to generate a composite quality score based on the information. The composite quality score may be based on a Mean Opinion Score (MOS), post-dial delay (PDD) and/or latency associated with the respective call.

In any implementations, the one or more processors may be associated with a SIP server.

In any implementations, the monitoring environment may be operable to capture the information at a single location in a communications path between the two or more computing devices.

A method of monitoring call quality may include accessing information associated with a call. The method may include generating a composite quality score based on a Mean Opinion Score (MOS), post-dial delay (PDD) and/or latency associated with the information. The method may include communicating the composite quality score to a device.

In any implementations, the method may include displaying the composite quality score in a graphical user interface.

The present disclosure may include any one or more of the individual features disclosed above and/or below alone or in any combination thereof.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 discloses a communications system.

FIG. 2 discloses a system for monitoring call quality.

FIG. 3 discloses an audio stream including channels.

FIG. 4 discloses another audio stream including channels.

FIG. 5 discloses a method of monitoring call quality.

Like reference numbers and designations in the various drawings indicate like elements.

### DETAILED DESCRIPTION

Various techniques may be utilized to calculate or otherwise determine call quality. Some techniques may lead system administrators and service providers to incorrectly believe they have acceptable quality calls when parties to a phone call were unable to communicate successfully.

The disclosed systems and methods may be useful for determining call quality using one or more information sources. An overall (e.g., composite) quality score may be established based on a set of parameters. The composite quality score may be based on relatively more information than MOS or PESQ alone. The composite quality score may be representative of a single grade that may be useful for letting users or system administrators focus their attention on truly poor calls, which may improve the user experience by taking corrective action relatively sooner.

When a phone call is passed through a VOIP network, the audio may be packetized into many small chunks and transmitted. Each packet may represent approximately 20 milliseconds of audio, resulting in 50 packets per second of audio. Those packets may need to arrive at a relatively constant rate and most packets may need to arrive to have perfect call quality. Twenty milliseconds may be suitable because most humans may not notice 20 milliseconds of missing audio in speech, since the missing audio may be inferred from the surrounding sound. When a system monitors audio at a single point of the network the system may measure the jitter and/or packet loss. Jitter may be defined as a delta of arrival times from the (e.g., 20 milliseconds) schedule. Packet loss may be defined as how many packets are not delivered to the end user device.

Jitter and packet loss may indicate a variety of call quality problems, but they may not represent all of them, which may lead to an overstated quality score. The audio packets may carry no audio (e.g., silence), very low volume audio, and/or mostly noise due to system configuration issues (e.g., using the wrong codecs) and/or hardware issues.

A composite quality score may be calculated based on two or more parameters. The parameters may be assigned respective weights. Parameters of the composite quality score may include Post Dial Delay (PDD). PDD may be defined as the amount of time between dialing the last digit of a phone number and when the first ring back tone is heard. PDD may impact user perceived quality but is not included in MOS-only scores.

Parameters of the composite quality score may include latency in audio streams, which may be useful in detecting call quality issues. Latency may be determined based on end-to-end information. Active testing may be utilized to determine latency at each end of the phone call, but the determined latency may only be accurate for the configuration tested and may not be indicative of latency actual users may perceive during a call.

The disclosed techniques may be utilized to determine latency at a single point in a communications path that establishes the phone call between the (e.g., end) user devices. Insights from human speech patterns (e.g., that human speech is largely turn-based) may be utilized as an indicator of call latency.

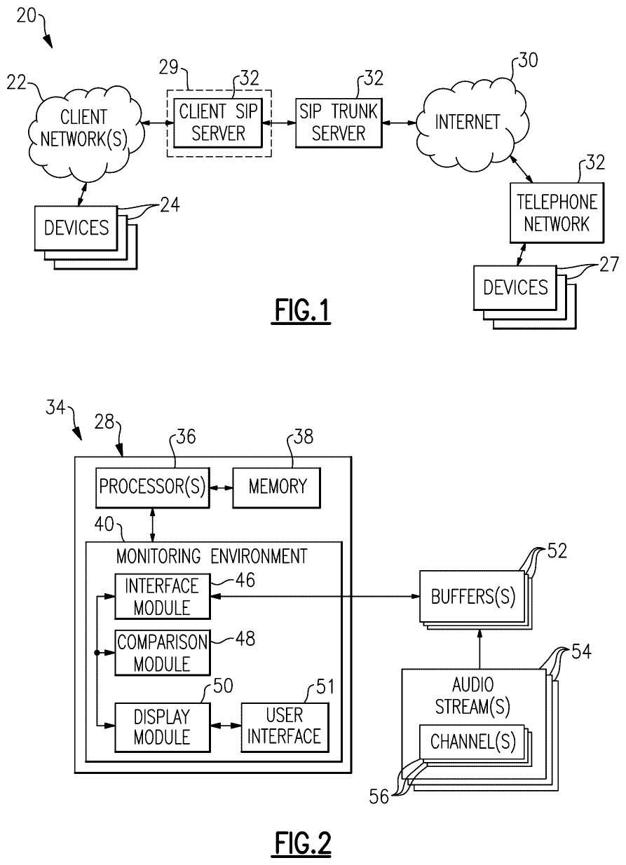

FIG. 1 discloses a communication system 20 according to an implementation. The system 20 may include a (e.g., client) network 22 may be operable to connect one or more computing devices 24 with various devices of the system 20. The computing devices 24 may include one or more Voice over IP (VOIP) phones, laptops, desktops, etc. The client network 22 may be established by one or more networking devices, such as servers, routers, switches, etc.

The system 20 may include one or more (e.g., client) SIP servers 26 and one or more (e.g., host) SIP trunk servers 28. The client server 26 and/or trunk server 28 may be operable to establish one or more SIP trunks 29. The SIP trunk server 28 may include a session border controller (SBC), SIP gateway, etc. The SIP trunk server 28 may be linked to or otherwise may have access to a telephone network 32. The telephone network 32 may include known equipment to facilitate calls in a known manner. The telephone network 32 may be operable to connect one or more (e.g., end user) computing devices 27 with various devices of the system 20. The computing devices 27 may include any of the devices disclosed herein, such as one or more VoIP phones, laptops, desktops, etc. The devices 24, 27 may be operable to initiate, receive and/or conduct phone calls.

The telephone network 32 may support one or more phone numbers. The SIP trunk server 28 may be operable to interconnect the client server 26 and the telephone network 32 via the internet 30. The host server 28 may be remote from the SIP trunk 29. The client server 26 may be operable to interconnect the trunk 29 and the telephone network 32. For every incoming or outgoing phone call across the trunk 29, one SIP channel may be established. The SIP channel may support one or more calls conducted at different times. Each call may include an audio stream having two or more channels.

The trunk 29 may be operable to interconnect one or more of the devices 24, 27 to each other. The trunk 29 may be operable to establish a respective SIP channel for phone calls between the devices 24, 27.

Referring to FIG. 2, with continuing reference to FIG. 1, a system 34 for monitoring call quality is disclosed. The system 34 may be incorporated into and/or may otherwise interface with the system 20. The system 34 may be incorporated into any of the devices of the system 20, such as the client server 26 and/or the trunk server 28. The system 20 may be operable to establish VoIP communications across the SIP trunk 29.

The system 34 may include one or more computing devices. Each computing device may include one or more computer processors, memory, storage means, network devices, input and/or output devices, and/or interfaces. The computing devices may be operable to execute one or more software programs, including the functionality of this description. The computing devices may be operable to communicate with one or more networks established by one or more computing devices. The memory may include UVPROM, EEPROM, FLASH, RAM, ROM, DVD, CD, a hard drive, or other computer readable medium which may store data and/or the functionality of this description. The computing devices may be a desktop computer, laptop computer, smart phone, tablet, or any other computer device. Input devices may include a keyboard, mouse, touchscreen, etc. The output devices may include a monitor, speakers, printers, etc. Each of the computing devices may include one or more processors coupled to memory. The computing devices may be coupled to each other by connection(s). The connection may be a wired and/or wireless connection. The connection may be established over one or more networks and/or other computing systems.

The system 34 may be utilized to determine the quality of one or more telephone calls between two or more (e.g., end) user devices. The system 34 may be operable to determine the quality of one or more, or all, calls at various locations between the user devices. In implementations, the system 34 may be operable to determine the quality of one or more, or all, calls at a single location of a communications path between the devices of the respective users. The communications (e.g., call) path may be associated with a respective SIP channel. In implementations, the system 34 may include one or more processors 36 coupled to memory 38. The processor(s) 36 may be collectively operable to execute a monitoring environment 40.

The monitoring environment 40 may be operable to determine the quality of one or more telephone calls, which may be between devices of the respective users. The monitoring environment 40 may be executable on a single computing device or may be distributed between two or more computing devices. The monitoring environment 40 may be executable on the trunk server 28 and/or client server 26. In implementations, portions of the monitoring environment 40 may be distributed between the trunk server 28 and/or client server 26. In implementations, the trunk server 28 may be operable to execute the monitoring environment 40 and the client server 26 may interact with the monitoring environment 40 through a thin-client or web browser to determine aspects of one or more phone calls, including call quality.

The system 34 may include a graphical user interface (GUI) 51 operable to display various information regarding one or more phone calls, including call quality. A user may interact with the GUI 51 to configure the monitoring environment 40 and/or view the information.

The monitoring environment 40 may include one or more modules for evaluating characteristics of one or more phone calls, including call quality. The monitoring environment 40 may include an interface module 46, a comparison module 48 and/or a display module 50. Although three modules are disclosed, fewer or more than three modules may be utilized to provide the disclosed functionality.

The interface module 46 may be operable to access data associated with phone calls established across a communications system, such as the system 20. The data may be stored in one or more messaging buffers 52. The buffer 52 may be established in memory 38 and/or another memory location. The interface module 46 may be operable to access data from the buffer 52. The buffer(s) 52 may be established by the client server 26 and/or the trunk server 28. The interface module 46 may be operable to access the data in response to initiation of at least one call associated with the trunk 29. The data may be associated with at least one call and/or other event between the trunk 29 and the telephone network 32. The call may be initiated by the client server 26 and/or one of the devices 24, 27. A copy of the data may be stored in the buffer(s) 52. The monitoring environment 40 and/or client server 26 may be operable to store the data in the buffer(s) 52. The buffer 52 may be operable to store a copy of traffic (e.g., audio stream) associated with one or more calls between the devices 24, 27 and/or other events between the trunk 29 and the telephone network 32 and/or another device connected to the internet 30.

The comparison module 48 may be operable to evaluate the quality of one or more phone calls, including calls between the devices 24, 27 at various points in the call path, such as a single point between the devices 24, 27, or more than one point. In implementations, the comparison module 48 may be operable to generate (e.g., assign) a quality score to one or more respective phone calls, which may be associated with information in the buffer(s) 52. The comparison module 48 may be operable to generate quality scores utilizing any of the techniques disclosed herein. The display module 50 may be operable to display information associated with the call quality, including any of the information disclosed herein, such as a quality score associated with a respective phone call.

Various techniques may be utilized to determine a (e.g., composite) quality score of a respective phone call. The disclosed techniques for calculating a composite quality score may include a combination of various parameters, including a MOS. Techniques for determining a MOS are known, but determining a quality score based on MOS utilizing the teachings disclosed herein are not known. The MOS parameter may be assigned a value from a preselected range. In implementations, the preselected range for MOS parameter may be between 1.0 and 5.0. A value of 1.0 may be associated with a minimum (e.g., poor) quality score. A value of 5.0 may be associated with a maximum (e.g., excellent or perfect) MOS. Other minimum and/or maximum values for the MOS parameter may be utilized in accordance with the teachings disclosed herein. The composite quality score may include other parameters, such as post dial delay (PDD). Techniques for determining PDD are known, but determining a quality score based on PDD utilizing the teachings disclosed herein are not known.

The composite quality score may be calculated with respect to the following conditions. If a threshold quantity of audio packets do not meet one or more preselected thresholds (e.g., energy too low and/or too high), then the call may assigned a quality score of 1.0. The threshold quantity may include a majority or vast majority (e.g., >75%) of the audio packets of the respective call and/or a sample of the audio packets.

As previously discussed, jitter and packet loss may cause relatively poor call quality. The audio packets may carry no audio, very low volume audio, and/or mostly noise due to system configuration issues and/or hardware issues. In implementations, a quality score of 1.0 may be assigned to the call in response to determining jitter and/or packet loss associated with the channel(s) 56 of the audio stream 54 exceeding a respective jitter threshold and/or packet loss threshold.

If the audio packets meet the preselected threshold(s), then a quality score may be calculated based on two or more parameters, including any of the parameters disclosed herein. In implementations, the parameters may include MOS and/or PDD. The comparison module 40 may be operable to measure MOS and/or PDD based on information associated with the audio packets of the respective call, which may be stored in the buffer(s) 52.

The PDD parameter may be calculated using the following formula:

$$PDD = {PDD}_{IDEAL} - ( minimum ( {PDD}_{DEFAULT} , {PDD}_{MEASURED} ) )$$

where PDD_{IDEAL} may correspond to the best measurable call experience, PDD_{DEFAULT} is an assumed delay time, and PDD_{MEASURED} is the actual delay. In implementations, PDD_{IDEAL} may be assigned a value of 4.5. PDD_{DEFAULT} may be assigned a value of 5.0. PDD_{DEFAULT} may correspond to the worst possible score beyond which it does not matter. The value of PDD_{DEFAULT} may be set to 4.5 so the calculated PDD is never negative, which may prevent PDD from overwhelming the composite quality score.

A composite quality score may be calculated using the following formula:

$$Composite quality score = ( W 1 * MOS ) + ( W 2 * PDD )$$

where W1, W2 are assigned weights. The weights W1, W2 may be the same or may differ. In implementations, the weight W1 may be assigned a value of 0.75. The weight W2 may be assigned a value of 0.25. The composite quality score may be assigned a value within a preselected range. The preselected range may be the same or may differ from a preselected range associated with the MOS parameter. In implementations, the preselected range may be between 1.0 and 4.5. A value of 1.0 may be associated with a minimum score and a value of 4.5 may be associated with a maximum score.

Weights assigned to parameters of the composite quality score may be established based on various techniques. In implementations, weights (e.g., W1, W2) assigned to parameters of the composite quality score (e.g., MOS, PDD, latency, etc.) may be established based on machine learning techniques and/or statistical analysis. The machine learning training set and/or statistical analysis may be based on various information including human generated quality scores of calls. Various machine learning models may be utilized, such as a neural network.

Table 1 discloses non-limiting examples of composite quality scores associated with different call scenarios. In the following examples, a composite quality score of 4.5 may be a maximum (e.g., excellent or perfect) score, and a composite quality score of 1.0 may be a minimum (e.g., poor) score, although other values may be utilized.

TABLE 1

| | | PDD | Quality |
|---|---|---|---|
| Scenario | MOS | (secs) | Score |
| 1: Excellent | 4.5 | 0.1 | 4.5 |
| 2: Long setup delay | 4.3 | 6.0 | 3.1 |
| 3: Bad Audio | 2.0 | 3.0 | 1.9 |

In the third scenario associated with a composite quality score of 3.1, the call may be associated with an excessively long setup time, which may cause a relatively bad user experience. As a result, the combination of values of MOS and PDD may result in a decrease in a composite quality score from 4.3 (e.g., MOS-only) to 3.1.

The monitoring environment 40 may be operable to store and/or communicate all values of the parameters and resultant quality score(s) to one or more computing devices, including any of the devices disclosed herein. The value(s) of the parameters and resultant composite quality score(s) may be communicated to one or more users associated with the devices. The values and/or quality score(s) may be stored in memory 38. The monitoring environment 40 may be operable to communicate information associated with the quality score to one or more devices, including the calculated quality score, the values of any and/or all parameters used to calculate the score. The display module 50 may be operable to display the information in a graphical user interface accessible by a user.

Other parameters may be utilized to determine a composite quality score of a respective phone call, including latency. When people speak to each other, many languages use a turn-based way of speaking. One person speaks while others listen. Once the speaker completes a statement, then the listener may respond. There may be some instances where a listener might interrupt a speaker or where a receiver might not respond to a speaker, but in general conversations flow through a turn-based model. When an audio stream starts to experience latency, the pauses between the speaker and listener may become relatively longer. At higher levels of latency the speaker and listener may start to overlap on the beginning of a turn. In one scenario, a speaker may end saying something, may wait an amount of time, and then the receiver may start to respond at about the same time as the speaker saying something (e.g., “Did you hear me?”).

In single point (e.g., passive) monitoring, latency may not be measurable directly because the monitoring point is a single point in a communications path that may be established by multiple communications devices. The time between the initial sender and the final receiver receiving the call may not be measurable at the single point.

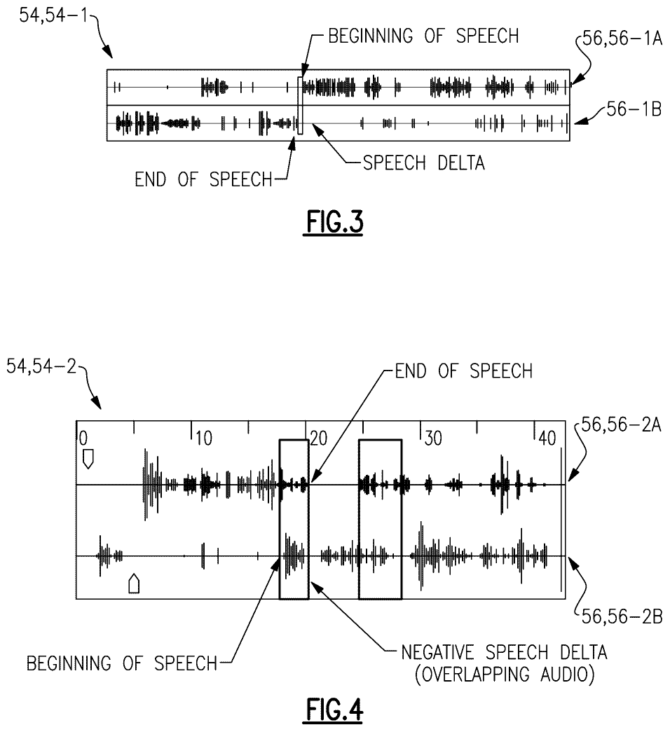

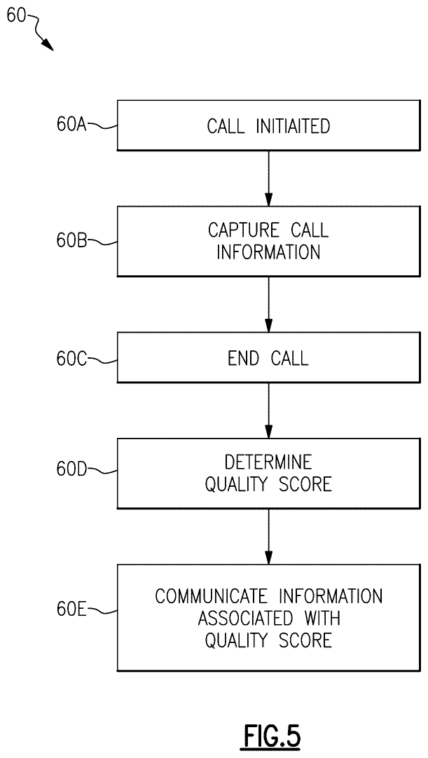

An audio stream 54 may be associated with two or more channels 56. User computing devices (e.g., devices 24, 27) may be assigned respective channels 56 of the phone call. Data associated with the audio stream(s) 54 may be stored in the messaging buffer(s) 52 and/or another memory location. The interface module 46 may be operable to access data associated with the audio stream(s) 54. In the implementation of FIG. 3, audio stream 54-1 may include channels 56-1A, 56-1B. In the implementation of FIG. 4, audio stream 54-2 may include a first channel 56-2A and a second channel 56-2B. In other implementations, the audio stream 54 may include three or more channels 56 (e.g., conference call).

The comparison module 48 may be operable to determine conversation turn changes, where a speaker may become a listener and/or vice versa. The comparison module 48 may be operable to determine conversation turn changes associated with the audio stream 54 by determining whether an energy level of one channel 56 meets an energy threshold (e.g., energy associated with a speaker) and an energy level of another channel 56 does not meet the energy threshold (e.g., relatively less or no energy associated with a receiver) and then when the channel energy levels may alternate. The comparison module 48 may be operable to calculate a speech delta equal to an amount of time between the last energy from the speaker and the first energy of the receiver. The speech delta may be a positive value (e.g., FIG. 3). In scenarios, the speech delta may be a negative value (e.g., FIG. 4), such as when the receiver begins to speak prior to the speaker finishing a statement.

The comparison module 48 may be operable to calculate all speech deltas during an (e.g., entire) length of a single phone call associated with a respective audio stream 54. The comparison module 48 may be operable to count a total number of transitions (e.g., all speech deltas), a total number of positive speech deltas, and/or a total number of negative speech deltas during the phone call. In implementations, if the total number of negative speech deltas is greater than a preselected threshold (e.g., 25% of the total number of transitions), the comparison module 48 may assign a latency score of 1.0 to the call. A latency score 1.0 may identify the phone call as potentially latent due to a relatively large number of interruptions.

The comparison module 48 may be operable to determine whether the energy of a channel 56 may be associated with music (e.g., hold music). The comparison module 48 may be operable to exclude from the total number of transitions any transitions associated with music. Transitions associated with music may render inaccurate a latency determination. The comparison module 48 may be operable to determine whether the energy of a channel 56 is associated with music or another source than a human utilizing various techniques (e.g., one or more frequencies associated with musical instruments, etc.).

The comparison module 48 may be operable to exclude from the total number of transitions any transitions in which the speech delta meets a preselected criterion. The preselected criterion may be associated with a preselected range (e.g., between-500 milliseconds and 500 milliseconds). Speech deltas within the preselected range may be associated with normal transitions that may not indicate (e.g., abnormal) latency.

The comparison module 48 may be operable to calculate a statistical summary of the absolute value(s) of the speech delta(s) during a single phone call (e.g., average, 90th percentile distribution or one standard deviation). If the speech delta associated with the statistical summary is above a latency threshold, the comparison module 48 may identify the call as having latency. Latency may be calculated using the following formula:

$$Latency = ( {SD}_{IDEAL} - ( Speech Delta - {SD}_{DEFAULT} ) * SF )$$

where Latency may be measurable in seconds, SD_{IDEAL} may correspond to the best measurable call experience, SD_{DEFAULT} is an assumed delay time in which a user may think about what to say prior to speaking, and SF is a scaling factor. In implementations, SD_{IDEAL} may be assigned a value of 4.5. SD_{DEFAULT} may be assigned a value of 0.5. The scaling factor SF may be assigned a value of 2.5.

A composite quality score may be calculated using the following formula:

$$Composite quality score = ( W 1 * MOS ) + ( W 2 * PDD ) + ( W 3 * Latency )$$

where W1, W2, W3 are assigned weights. The weights W1, W2, W3 may be the same or may differ. In implementations, the weight W1 may be assigned a value of 0.375. The weight W2 may be assigned a value of 0.25. The weight W3 may be assigned a value of 0.375.

Table 2 discloses non-limiting examples of composite quality scores associated with different call scenarios with respect to calculated latency.

TABLE 2

| | | PDD | Latency | Quality |
|---|---|---|---|---|
| Scenario | MOS | (secs) | (secs) | Score |
| 1: Excellent | 4.5 | 0.1 | 0.1 | 4.5 |
| 2: Long setup | 4.3 | 6.0 | 0.1 | 3.2 |
| delay | | | | |
| 3: Bad Audio | 2.0 | 3.0 | 1.5 | 2.9 |
| 4: High Latency | 4.3 | 0.1 | 1.5 | 3.5 |

In the first two scenarios, relatively low latency may be associated with relatively high composite quality scores. The third scenario associated with bad audio may be assigned a relatively lower composite quality score, which may be similar to a quality score calculated based on MOS and PDD, but without latency (see, e.g., scenario 3 of Table 1). The relatively high latency associated with the fourth scenario may be assigned a relatively lower quality score than a quality score calculated based on MOS and PDD, but without latency. The fourth scenario illustrates that calculating a quality score based on latency may be useful for identifying a relatively poor call that may otherwise be identified as a relatively good call were latency not to be considered.

In implementations, the PDD parameter may be omitted from the composite quality score. A composite quality score may be calculated using the following formula:

$$Composite quality score = ( W 1 * MOS ) + ( W 2 * Latency )$$

where W1, W2 are assigned weights. The weights W1, W2 may be the same or may differ. In implementations, the weight W1 may be assigned a value of 0.75. The weight W2 may be assigned a value of 0.25.

FIG. 5 discloses a method of monitoring call quality in a flow chart 60 according to an implementation. The method 60 may be utilized to determine call quality between two or more communications (e.g., end user) devices. The method 60 may include generating a composite quality score associated with a quality of a phone call. The quality score may be based on information monitored or otherwise obtained at a single point in a communications (e.g., call) path between the (e.g., end) user devices of a respective phone call, or at multiple points in the path. Fewer or additional steps than are recited below could be performed within the scope of this disclosure, and the recited order of steps is not intended to limit this disclosure. The monitoring environment 40 may be programmed with logic for performing method 60. Reference is made to the systems 20, 34.

At block 60A, a phone call may be initiated between two or more (e.g., end) user devices. The call may be established between any of the devices of the system 20. The call may be associated with an audio stream 54 including two or more channels 56 (FIG. 2). The audio stream 54 and channels 56 may be associated with one or more audio packets.

At block 60B, information associated with the audio stream 54 of the respective call may be captured. The information may include one or more audio packets, which may be stored in memory such as a buffer 52.

At block 60C, a composite quality score for the call may be assigned, calculated, or otherwise determined. The quality score may be based on the information obtained at block 60B. The composite quality score may be determined utilizing any of the techniques disclosed herein.

At block 60D, information associated with the quality score may be communicated to one or more devices, including any of the devices of the system 20. The information may include the audio packets and/or associated characteristics of the audio stream 52 such as energy of the channel(s) 56, duration of the call, etc. The information may include a value of the composite quality score and/or values associated with parameters of the quality score (e.g., MOS, PDD, latency, etc.).

At block 60E, information associated with the composite quality score may be communicated to one or more communications devices, including any of the devices disclosed herein. In implementations, block 60E may include generating one or more indicators (e.g., alerts) in response to the quality score being below a preselected threshold, which may be indicative of a connectivity and/or configuration issue, etc. The indicator(s) may be communicated to the communications device(s), which may be utilized for diagnostics and/or corrective action.

The disclosed systems and methods may be useful in determining and correcting connectivity and/or configuration issues (e.g., of a SIP trunk) that may cause relatively poor call quality. The disclosed techniques may be utilized to determine relatively more accurate call quality scores, which may be evaluated as a single metric. Latency on audio streams may be determined at a single point in the call path without having to monitor end points with instrumentation and without changing a user's behavior. Monitoring call quality at a single point may be achieved without access to the end user devices. A service provider may initiate corrective action based on the composite quality score to diagnose a potential issue with the connection without waiting for a user to report an issue, which may improve the user experience.

Although the different examples have the specific components shown in the illustrations, embodiments of this disclosure are not limited to those particular combinations. It is possible to use some of the components or features from one of the examples in combination with features or components from another one of the examples.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A system for monitoring call quality comprising:
one or more processors coupled to memory, wherein the one or more processors are collectively operable to execute a monitoring environment, and the monitoring environment is operable to:
obtain information associated with a call between two or more computing devices; and
generate a composite quality score for the call based on the information, wherein the composite quality score is based on a plurality of parameters associated with the call, and wherein the parameters include at least one of a Mean Opinion Score (MOS), a post-dial delay (PDD) and a latency associated with the call.

2. The system as recited in claim 1, wherein the parameters include the MOS and PDD associated with the call.

3. The system as recited in claim 2, wherein the parameters include the latency associated with the call.

4. The system as recited in claim 1, wherein the one or more processors are associated with a SIP server.

5. The system as recited in claim 1, wherein the monitoring environment is operable to capture the information at a single location in a communications path between the two or more computing devices.

6. The system as recited in claim 5, wherein:
the parameters include the latency associated with the call; and
the monitoring environment is operable to determine the latency associated with the call at the single location.

7. The system as recited in claim 6, wherein:
the call includes an audio stream having two or more channels;
the monitoring environment is operable to determine a set of speech deltas associated with the audio stream that occur during a duration of the call; and
the monitoring environment is operable to calculate the latency based on the set of speech deltas.

8. The system as recited in claim 7, wherein the monitoring environment is operable to calculate the latency based on a statistical summary of the set of speech deltas.

9. The system as recited in claim 7, wherein the monitoring environment is operable to exclude any speech deltas from the calculated latency in response to the respective speech delta meeting a preselected criterion.

10. The system as recited in claim 1, wherein the monitoring environment is operable to cause the composite quality score to be displayed in a graphical user interface.

11. The system as recited in claim 1, wherein the monitoring environment is operable to:
assign weights to the respective parameters; and
calculate the composite quality score based on the assigned weights.

12. The system as recited in claim 11, wherein the monitoring environment is operable to:
establish the weights based on a machine learning model.

13. The system as recited in claim 1, wherein:
the call includes an audio stream having two or more channels; and
the monitoring environment is operable to:
determine whether a threshold quantity of audio packets associated with the audio stream meets a minimum energy limit and a maximum energy limit; and
assign a minimum value to the composite quality score in response to the determined threshold quantity of audio packets not meeting the minimum and maximum energy limits, but assign a value to the composite quality score based on the plurality of parameters in response to the threshold quantity of audio packets meeting the minimum and maximum energy limits.

14. The system as recited in claim 1, wherein:
the call includes an audio stream having two or more channels; and
the monitoring environment is operable to:
determine jitter and packet loss associated with the two or more channels of the audio stream; and
assign a minimum value to the composite quality score in response to the jitter exceeding a jitter threshold or the packet loss exceeding a packet loss threshold, but assign a value to the composite quality score based on the plurality of parameters in response to the determined jitter and the determined packet loss being below the respective jitter and packet loss thresholds.

15. A method of monitoring call quality comprising:
accessing information associated with a call;
generating a composite quality score for the call based on a plurality of parameters associated with the call, and wherein the parameters include at least one of a Mean Opinion Score (MOS), a post-dial delay (PDD) and a latency associated with the information; and
communicating the composite quality score to a computing device.

16. The method as recited in claim 15, wherein the parameters include the MOS and PDD associated with the call.

17. The method as recited in claim 15, wherein the parameters include the latency associated with the call.

18. The method as recited in claim 17, wherein the call includes an audio stream having two or more channels, and further comprising:
determining the latency associated with the call at a single location in a communications path between two or more computing devices associated with the respective two or more channels based on a set of speech deltas that occur during a duration of the call.

19. The method as recited in claim 15, further comprising:
generating one or more indicators in response to the composite quality score being below a preselected threshold; and
communicating the one or more indicators to the computing device.

20. The method as recited in claim 15, further comprising:
causing the composite quality score to be displayed in a graphical user interface associated with the computing device.
